(19) United States
(12) Patent Application Publication
(10) Pub. No.: US 2014/0344628 A1
(43) Pub. Date: Nov. 20, 2014

(54) CERTIFICATION OF NON-NATIVE DATA LAYOUT IN A MANAGED RUNTIME SYSTEM

(71) Applicant: International Business Machines Corporation, Armonk, NY (US)

(72) Inventors: Richard N. Chamberlain, Southampton (GB); Howard J. Hellyer, Winchester (GB); Matthew F. Peters, Romsey (GB); Adam J. Pilkington, Eastleigh (GB)

(73) Assignee: International Business Machines Corporation, Armonk, NY (US)

(21) Appl. No.: 13/893,512

(22) Filed: May 14, 2013

(51) Int. Cl. G06F 9/455; G06F 11/30

(52) U.S. Cl. CPC G06F 9/45533; G06F 11/301
USPC 714/47.1

(57) ABSTRACT

One embodiment of the present invention discloses a method, computer program product, and system for conditioning a memory region. An exemplary embodiment determines an anticipated form of an object. An exemplary embodiment determines a memory region for the object. An exemplary embodiment encodes the anticipated form of the object. An exemplary embodiment inserts the encoding of the anticipated form of the object into the memory region for the object. An exemplary embodiment acquires the object. An exemplary embodiment determines a form of the object. An exemplary embodiment compares the form of the object with the anticipated form of the object. An exemplary embodiment indicates an error if the form of the object differs from the anticipated form of the object.

### FIELD OF THE INVENTION

The present invention relates generally to the design and development of managed runtime systems and more specifically to the integration of data and program components from disparate computer architectures into a functioning runtime system.

### BACKGROUND OF THE INVENTION

A runtime system manages a program's execution on a computer primarily by managing the memory that the executing program uses and by acting as an interface to resources that the executing program may request. A managed runtime system, on the other hand, usually refers to a system that executes a program that has been compiled to an intermediate language on a virtual machine that understands the program. A virtual machine is a software program that simulates a machine that is usually different from the machine that the virtual machine is executing on, i.e., a host machine. A managed runtime system often enables many operations that are performed before a program executes in a non-managed system to be performed during the program's execution, i.e., during runtime.

Data and code requested by a program and acquired during the runtime of the program are often loaded into a memory space of a virtual machine, into a large pool of memory called a heap. Sometimes the data and code are loaded into a host's memory space that is not part of the virtual machine's heap and a pointer to that data and code is placed on the heap instead.

### SUMMARY

One embodiment of the present invention discloses a method, computer program product, and system for conditioning a memory region. An exemplary embodiment determines an anticipated form of an object. An exemplary embodiment determines a memory region for the object. An exemplary embodiment encodes the anticipated form of the object. An exemplary embodiment inserts the encoding of the anticipated form of the object into the memory region for the object. An exemplary embodiment acquires the object. An exemplary embodiment determines a form of the object. An exemplary embodiment compares the form of the object with the anticipated form of the object. An exemplary embodiment indicates an error if the form of the object differs from the anticipated form of the object.

### BRIEF DESCRIPTION OF THE SEVERAL VIEWS OF THE DRAWINGS

FIG. 1 is a block diagram illustrating a distributed data processing environment, in accordance with an embodiment of the present invention.

FIG. 2 is a flowchart depicting an exemplary embodiment of a behavior of Java® native class loader for conditioning a memory region, in accordance with an embodiment of the present invention.

FIG. 3 depicts a block diagram of components of the host computer and non-host computer, in accordance with an embodiment of the present invention.

### DETAILED DESCRIPTION

By placing pointer to the host's memory space on the heap, the host's memory is shared between the host and the virtual machine, and efficiencies in performance may ensue because the overhead of copying data between the memory spaces may be eliminated. Memory on the heap is allocated and freed as necessary during a program's execution. Because data and code can originate in systems other than the host, there are opportunities for errors in the way the code and data are expressed when placed on a heap (or in shared memory) compared to the way the host or virtual machine expects the code and data to be expressed on the heap (or in shared memory). Code and data can be expressed differently on different machines. Such errors can be very difficult and time consuming to find, especially during the development and debug of a new program that may have some of its components distributed on other machines or during a design or an enhancement of a virtual machine.

For example, Java® executes on a virtual machine. Java and all Java-based trademarks and logos are trademarks or registered trademarks of Oracle and/or its affiliates. Java is an object-oriented programming language whose programs are composed of instances of classes that contain data and methods. A class is a group of code and data that represents something, an object, and a method in the class is code that performs a function associated with the object. The methods in a class act as an interface to the object the class represents and may be called, or invoked, by other classes and other parts of a Java program. A Java managed runtime system can acquire program code and classes for a Java program that is executing on a Java Virtual Machine (JVM)—from storage on the host or on other computers connected to the host. This capability enables classes be acquired as needed during a program's execution from other computers over a network. The Java language is designed to exploit networks.

If a method in a class is called by a Java program executing on a JVM on a host, a Java® class loader subsystem of the JVM locates the class that includes the method, either on the host or on other systems in a network, and retrieves the class. The Java class loader makes the class accessible to the Java program and the JVM and certifies that the form of the data and code in the class conforms to a form that the program and the JVM expect. The form may include the lengths of integers, floating point format, and whether Big Endian or Little Endian byte order is used. While standard Java class libraries are expressed in a specified form that is not machine-dependent, and can therefore be moved from machine to machine without consequence, the form of data and code in a native class library is machine-dependent. A Java native class library contains classes that contain native methods. A native method may be written in machine code, i.e., the method may be written in the instructions of an actual machine, and is therefore machine-dependent. Java native methods are commonly used by a JVM to access the resources of the host, e.g., file I/O or an audio device. Java native methods may also be employed by a Java application when speed and efficiency is critical (e.g., solving complicated mathematical equations), or when a desired functionality is not provided by the JVM. Because the form of the contents of a Java native method is machine-dependent, a Java native class library may inadvertently contain code and data that differ in form from that anticipated by the host machine, especially if the library resides on a machine other than the host. Subtle errors caused by a difference from anticipated form can destabilize a JVM in ways that are extremely difficult to reproduce, trace, and remedy.

In exemplary embodiments, if Java program 114 allocates memory that Java program 114 then passes back to the native code to populate the native code, Java program 114 could automatically populate the native code with the encoded form and allow the native code to validate it. Although the description below focuses on transfers between native code and a managed runtime, it could be implemented in reverse.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

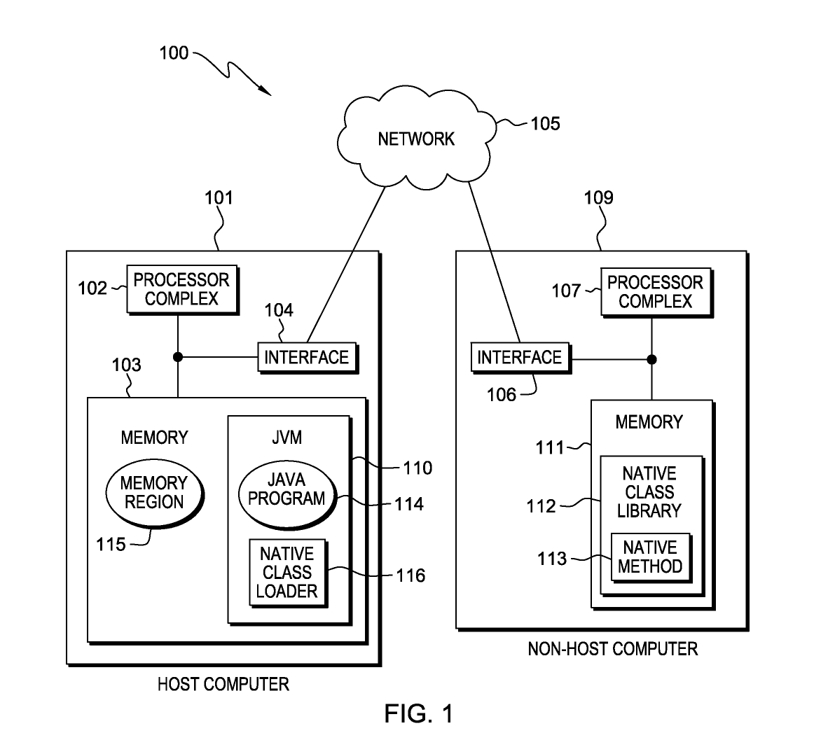

The present invention will now be described in detail with reference to the Figures. FIG. 1 is a block diagram illustrating a distributed data processing environment, generally designated 100, in accordance with one embodiment of the present invention. In an exemplary embodiment, a Java specification describes the form of all objects that are manipulated by the Java virtual machine, e.g., the size of the objects and the byte-order of the objects. However, a Java native method may be loaded using a Java native class loader into a Java virtual machine (JVM), from a computer other than a computer that is hosting the JVM. In exemplary embodiments, distributed data processing environment 100 includes host computer 101 and non-host computer 109, interconnected over network 105.

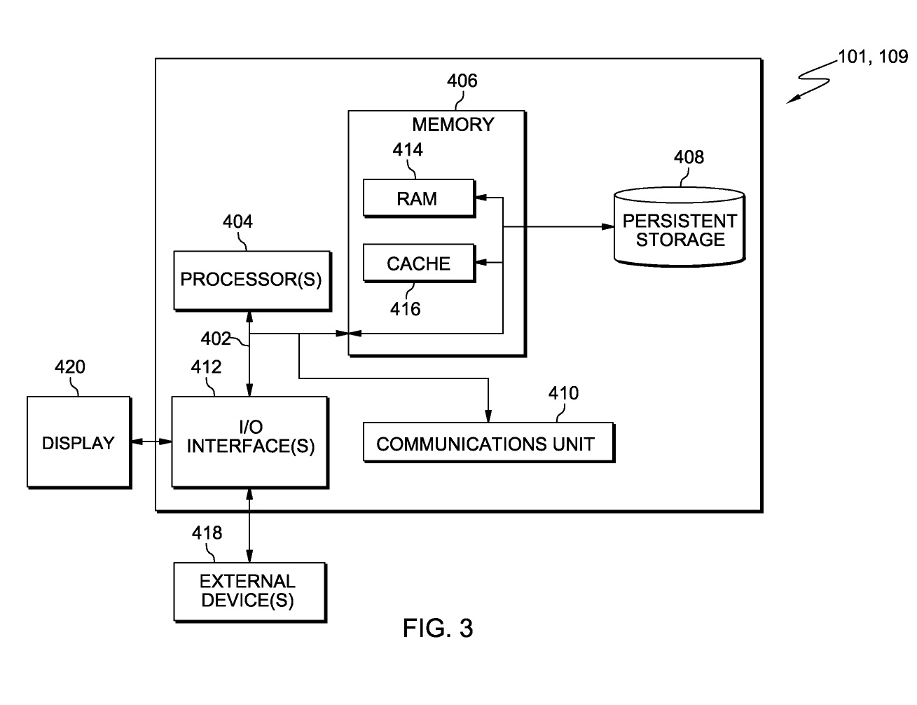

Host computer 101 may be a laptop computer, tablet computer, netbook computer, personal computer (PC), a desktop computer, a personal digital assistant (PDA), a smart phone, or any programmable electronic device capable of communicating with non-host computer 109 via network 105. Host computer 101 may include internal and external hardware components, as depicted and described in further detail with respect to FIG. 3.

Non-host computer 109 may be a laptop computer, tablet computer, netbook computer, personal computer (PC), a desktop computer, a personal digital assistant (PDA), a smart phone, or any programmable electronic device capable of communicating with host computer 101 via network 105. Non-host computer 109 may include internal and external hardware components, as depicted and described in further detail with respect to FIG. 3.

Network 105 can be, for example, a local area network (LAN), a wide area network (WAN) such as the Internet, or a combination of the two, and can include wired, wireless, or fiber optic connections. In general, network 105 can be any combination of connections and protocols that will support communications between host computer 101 and non-host computer 109.

FIG. 1 depicts host computer 101 that hosts JVM 110. When Java program 114 executing in JVM 110 invokes Java native method 113 in Java native class library 112 in memory 111 of non-host computer 109, JVM 110 invokes Java native class loader 116 that conditions memory region 115 with an encoding of an anticipated form of Java native method 113. Java native class loader 116 queries non-host computer 109 for Java native method 113 and processor complex 107 responds by transferring Java native method 113 through interface 106 to interface 104 on host computer 101 via network 105. Java native class loader 116 in JVM 110 that is executing on processor complex 102 transfers Java native method 113 to memory region 115 of memory 103 on host computer 101, compares a form of native method 113 with the anticipated form of Java native method 113 that is encoded in memory region 115 and makes Java native method 113 available to Java program 114.

If the anticipated form of Java native method 113 matches the form of Java® native method 113, the execution of Java program 114 continues, otherwise an error is logged that includes information on a lack of a match between the anticipated form of Java native method 113 and the form of Java native method 113, and the execution of Java program 114 is terminated. An ability to log a descriptive error if the form of Java native method 113 differs from the anticipated form of Java native method 113 facilitates a debugging of new or enhanced JVM systems and a writing of Java applications that include code that is developed on and may reside on computers other than the host computer.

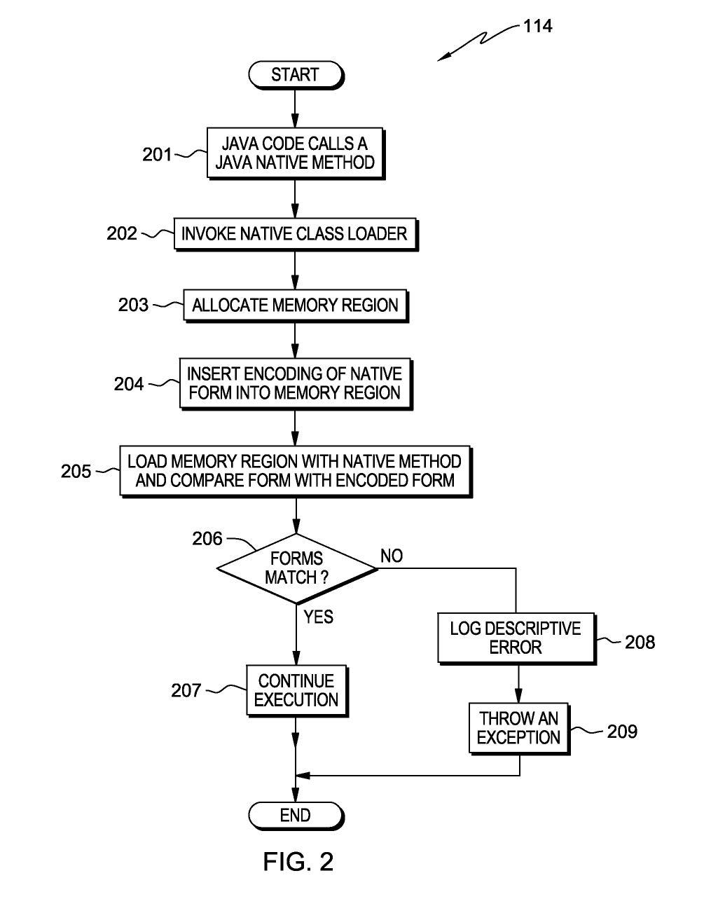

FIG. 2 is a flow chart of the exemplary embodiment of a behavior of Java native class loader 116. In step 201, a code in Java program 114 calls Java native method 113 while Java program 114 is executing in JVM 110. A calling of Java native method 113 in step 201 causes JVM 110 to invoke Java native class loader 116 in step 202. Java native class loader 116 allocates memory region 115 for Java native method 113 in step 203, and java native class loader 116 inserts an encoding of an anticipated form of Java native method 113 into memory region 115 in step 204. In step 205, Java native class loader 116 causes Java native method 113 to be transferred from non-host computer 109 to JVM 110 in host computer 101, where Java native class loader 116 loads Java native method 113 into memory region 115 while comparing the form of Java native method 113 with the encoded anticipated form of Java native method 113 that resides in memory region 115. In step 206, if the anticipated form of Java native method 113 matches the form of Java native method 113, JVM 110 allows the execution of Java program 114 to continue in step 207, otherwise JVM 110 logs a descriptive error in step 208 and an exception is thrown in step 209.

FIG. 3 depicts a block diagram of components of host computer 101 and non-host computer 109 in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Host computer 101 and non-host computer 109 include communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Java program 114 is stored in persistent storage 408 for execution by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices. In these examples, communications unit 410 includes one or more network interface cards. Communications unit 410 may provide communications through the use of either or both physical and wireless communications links. Java program 114 may be downloaded to persistent storage 408 through communications unit 410.

I/O interface(s) 412 allows for input and output of data with other devices that may be connected to host computer 101 and non-host computer 109. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention, e.g., Java program 114, can be stored on such portable computer-readable storage media and can be loaded onto persistent storage 408 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for conditioning a memory region, the method comprising the steps of:
determining an anticipated form of an object;
determining a memory region for the object;
encoding the anticipated form of the object;
inserting the encoding of the anticipated form of the object into the memory region for the object;
acquiring the object;
determining a form of the object;
comparing the form of the object with the anticipated form of the object; and
indicating an error if the form of the object differs from the anticipated form of the object.

2. The method of claim 1, wherein the object is a Java native method.

3. The method of claim 1, wherein the encoding is a bit pattern having a number of bits that is less than or equal to a number of bits in the memory region.

4. The method of claim 2, wherein the anticipated form of the object is acquired from a declaration of a Java class that defines the Java native method.

5. The method of claim 1, wherein, the object in the acquiring step resides on a computer system other than a computer system that contains the memory region.

6. The method of claim 2, wherein the memory region in the determining step is on a heap of a Java virtual machine (JVM).

7. The method of claim 2, wherein the memory region in the determining step is not on a heap of a JVM.

8. A computer program product for conditioning a memory region, the computer program product comprising:
one or more computer-readable storage media and program instructions stored on the one or more computer-readable storage media, the program instructions comprising:
program instructions to:
determine an anticipated form of an object;
determine a memory region for the object;
encode the anticipated form of the object;
insert the encoding of the anticipated form of the object into the memory region for the object;
acquire the object;
determine a form of the object;
compare the form of the object with the anticipated form of the object; and
indicate an error if the form of the object differs from the anticipated form of the object.

9. The computer program product of claim 8, wherein the object is a Java native method.

10. The computer program product of claim 8, wherein the encoding is a bit pattern having a number of bits that is less than or equal to a number of bits in the memory region.

11. The computer program product of claim 9, wherein the anticipated form of the object is acquired from a declaration of a Java class that defines the Java native method.

12. The computer program product of claim 8, wherein the object in the acquiring step resides on a computer system other than a computer system that contains the memory region.

13. The computer program product of claim 9, wherein the memory region in the determining step is on a heap of a Java virtual machine (JVM).

14. The computer program product of claim 9, wherein the memory region in the determining step is not on a heap of a JVM.

15. A computer system for conditioning a memory region, the computer system comprising:
one or more computer processors;
one or more computer-readable storage media;
program instructions stored on the computer-readable storage media for execution by at least one of the one or more processors, the program instructions comprising:
program instructions to:
determine an anticipated form of an object;
determine a memory region for the object;
encode the anticipated form of the object;
insert the encoding of the anticipated form of the object into the memory region for the object;
acquire the object;
determine a form of the object;
compare the form of the object with the anticipated form of the object; and
indicate an error if the form of the object differs from the anticipated form of the object.

16. The computer system of claim 15, wherein the object is a Java native method.

17. The computer system of claim 16, wherein the encoding is a bit pattern having a number of bits that is less than or equal to a number of bits in the memory region.

18. The computer system of claim 17, wherein the anticipated form of the object is acquired from a declaration of a Java class that defines the Java native method.

19. The computer system of claim 16, wherein the object in the acquiring step resides on a computer system other than a computer system that contains the memory region.

20. The computer system of claim 17, wherein the memory region in the determining step is on a heap of a Java virtual machine (JVM).
